(19) United States
(12) Patent Application Publication
(10) Pub. No.: US 2017/0092053 A1
(43) Pub. Date: Mar. 30, 2017

(54) METHOD FOR PLAYING A THREE CARD BOTTOMS UP COMPARING CARD GAME

(71) Applicant: Wayne Chiang, San Jose, CA (US)

(72) Inventor: Wayne Chiang, San Jose, CA (US)

(21) Appl. No.: 14/864,790

(22) Filed: Sep. 24, 2015

(51) Int. Cl. G07F 17/32; A63F 1/00

(52) U.S. Cl. CPC G07F 17/3225; A63F 1/00; G07F 17/3293; G07F 17/3244; G07F 17/322

(57) ABSTRACT

A method for playing a three card bottoms up comparing card game enables at least one player to wager directly against a dealer by comparing the rankings of three player cards against the correlating rankings of three dealer cards; whereby at least one player is dealt a player low card, a player middle card, and a player high card; whereby a dealer is dealt a dealer low card that is visible to the player and a dealer middle card and a dealer high card hidden from the player; whereby the player wagers that exactly two out of three player cards, or exactly three out of three player cards have a higher ranking hand than the correlating dealer cards; whereby the higher ranking hand comprises a higher ranking number and a higher ranking suit, avoiding a push; whereby optional side wagers based on the player and dealer cards are possible.

### FIELD OF THE INVENTION

The present invention relates generally to a method for playing a three card bottoms up comparing card game in which three cards of a player are compared against three cards of a dealer and wagered upon. More so, a method for playing a three card bottoms up comparing card game enables at least one player to wager directly against a dealer by comparing the rankings of three player cards against the correlating rankings of three dealer cards; whereby at least one player is dealt a player low card, a player middle card, and a player high card; whereby a dealer is dealt a dealer low card that is visible to the player and a dealer middle card and a dealer high card hidden from the player; whereby the player wagers that exactly two out of three player cards, or exactly three out of three player cards have a higher ranking hand than the correlating dealer cards; whereby the higher ranking hand comprises a higher ranking number and a higher ranking suit to avoid a push.

### BACKGROUND OF THE INVENTION

Typically, comparing card games are those where hand values are compared to determine the winner. Poker, blackjack, and baccarat are examples of comparing card games. It is known that, comparing card games are generally played for wagering and entertainment purposes. Nearly all comparing card games use a standard 52-card deck of playing cards (with thirteen values—2, 3, 4, 5, 6, 7, 8, 9, 10, Jack, Queen, King, and Ace—and four different suits: spades, hearts, diamonds, and clubs). Sometimes, one, two, or four “jokers” are added to the deck to serve as “wild cards,” which may be used to represent any card of any suit.

In many instances, comparing card games include the ability to make wagers. Often, a wager, or gamble in cards, is an agreement under which each player pledges a certain amount to the other depending on the outcome of an unsettled matter, such as a card total. The wager can be large or small. However, friendly card games may be played without wagers, much of the skill and excitement of card games come from the wagering system. Often, units are wagered. The units can be poker chips or other markers that are used and placed in a central area called a pot. Most comparing card games begin with an ante, or forced bet, by some or all of the players.

Often, there then follows one or more betting rounds wherein players have the opportunity to check (meaning to refrain from betting) or bet (sometimes up to a certain pre-set limit, and sometimes with no limit) by placing chips in the pot. Other players then have the option to “call” the bet by matching it, raise the bet by placing more chips in the pot, or fold, by surrendering their cards and forfeiting that hand. After the final betting round, if more than one player remains in the game, there is a showdown where the remaining players reveal their cards and the winner is determined by ranking the relative value of the hands, as discussed below.

In many instances, wagers offer a side bet on various outcomes including: a player hand and dealer's up card; a player initial hand is a pair; a player's initial hand is suited, suited and connected; and a player's initial hand plus dealer's card makes a flush, straight, or three-of-a-kind poker hand.

It is known that card counting is a casino card game strategy used primarily in comparing card games blackjack family of casino games to determine whether the next hand is likely to give a probable advantage to the player or to the dealer. Card counters are a class of advantage players, who attempt to decrease the inherent casino house edge by keeping a running tally of all high and low valued cards seen by the player. Card counting allows players to bet more with less risk when the count gives an advantage as well as minimize losses during an unfavorable count.

Thus, an unaddressed need exists in the industry to address the aforementioned deficiencies and inadequacies. Even though the above cited methods for playing comparing card games meets some of the needs of the market, a variation of a comparing card game that enables a player to wager directly against a dealer by comparing the rankings of three player cards against three correlating dealer cards is still desired.

### SUMMARY OF THE INVENTION

The present invention is directed to a method for playing a three card bottoms up comparing card game. The game enables at least one player to wager directly against a dealer by comparing the rankings of three player cards against three correlating dealer cards. The game also minimizes the detrimental effects of card counting due to the myriad combinations of cards that are compared and played.

The game commences by dealing three dealer cards to a dealer. The three dealer cards include a dealer low card that is visible to the player, and a dealer middle card and a dealer high card that are hidden from view of the player.

The at least one player is then dealt three player cards, which are concealed by the respective player. The three player cards include a player low card, a player middle card, and a player high card. Since the dealer low card is visible, the player immediately knows the comparing rank of the player low card to the correlating dealer low card.

At this point in the game, the player wagers that exactly two out of three player cards have a higher ranking hand than the correlating dealer cards. The player may also wager that exactly three out of three player cards have a higher ranking hand than the correlating dealer cards. The player may also take of the option of forfeiting and losing the initial ante.

After wagering, the dealer middle card and the dealer high card are made visible to the player, so as to commence the comparison between correlating low, middle, and high cards of the player and dealer (player high card-dealer high card; player middle card-dealer middle card; and player low card-dealer low card).

The player wins the game if the player low card ranks higher than the dealer low card, and/or the player middle card ranks higher than the dealer middle card, and/or the player high card ranks higher than the dealer high card. The higher ranking hand comprises a higher ranking number and a higher ranking suit to avoid a push.

In one embodiment, the rankings of the suit may include a Spade suit being the highest ranking, a Heart suit being the next highest ranking, a Diamond suit being the next highest ranking, and a Club suit being the lowest ranking suit. Thus in this ranking configuration, the lowest card is the 2 of Clubs and the highest card is the Ace of Spades. Though in some alternative embodiments, the rankings of the suits may follow any order and be predetermined before commencing the game.

For example, without limitation, a 10 of Hearts player low card ranks higher than a 10 of Diamonds dealer low card. A Jack of Hearts player middle card ranks lower than a Queen of Diamonds dealer middle card. An Ace of Hearts player high card ranks higher than a King of Hearts dealer high card. In this example, the player would beat the dealer if the player had wagered that exactly two out of three player cards have a higher ranking hand than the correlating dealer cards. However, the player would have lost to the dealer if the player had wagered that exactly three out of three player cards have a higher ranking hand than the correlating dealer cards.

The method for playing a comparing three card bottoms up game in which three player cards are compared against three dealer cards to determine a correlating rankings includes an initial Step of placing an initial ante, by at least one player, to participate in the game;

A subsequent Step may include dealing the three dealer cards to a dealer, the three dealer cards comprising a dealer low card that is dealt face up, a dealer middle card that is dealt face down, and a dealer high card that is dealt face down, whereby only the dealer low card is visible to the at least one player.

A Step may further include dealing the three player cards to the at least one player, the three player cards comprising a player low card that is dealt face down, a player middle card that is dealt face down, and a player high card that is dealt face down.

A Step may include comparing the player low card to the dealer low card, whereby the at least one player determines the rankings between the low cards;

The method may include a Step of placing a wager, by the at least one player, the wager based on exactly two out of three player cards having a higher ranking than the correlating dealer cards, or exactly three out of three player cards having a higher ranking than the correlating dealer cards, whereby the player low card is compared to the dealer low card, the player middle card is compared to the dealer middle card, and the player high card is compared to the dealer high card.

The method may include a Step of forfeiting the game, by the at least one player, whereby the at least one player loses the initial ante.

A Step comprises revealing the dealer middle card and the dealer high card to the at least one player.

A Step includes revealing the player low card, the player middle card, and the player high card to the dealer.

The method may then include a Step of comparing the three player cards to the correlating three dealer cards, whereby the player low card is compared to the dealer low card, the player middle card is compared to the dealer middle card, and the player high card is compared to the dealer high card.

A final Step includes resolving the wager of the at least one player based on whether exactly two out of three player cards have a higher ranking than the correlating dealer cards, or exactly three out of three player cards having a higher ranking than the correlating dealer cards, whereby the player low card is compared to the dealer low card, the player middle card is compared to the dealer middle card, and the player high card is compared to the dealer high card.

One objective of the present method is to increase the strategic possibilities in a comparing three card bottoms up game by comparing two sets of three cards.

Another objective is to increase the wagering opportunities by allowing the player to wager that exactly two out of three player cards have a higher ranking than the dealer cards, or exactly three out of three player cards have a higher ranking than the dealer cards.

Another objective is to orient the low, middle, and high cards across directly across from each other by utilizing a right to left—high low ranking for the dealer and a left to right—high low ranking for the player.

Another objective is to remove the possibility of a push at the end of the game by ranking the suits of the cards.

Another objective is to remove some of the randomness found in comparing games and add more strategy by providing two sets of cards.

Another objective is to enable the player to place a wager that is equal or double the initial ante.

Another objective is to provide alternative side wagers in some alternative embodiments of the game.

Another objective is to minimize the detrimental effects of card counting.

Another objective is to provide an entertaining alternative to traditional comparing card games.

### BRIEF DESCRIPTION OF THE DRAWINGS

The invention will now be described, by way of example, with reference to the accompanying drawings, in which:

FIGS. 1A and 1B illustrate a flowchart diagram of an exemplary method for playing a three card bottoms up comparing card game, in accordance with an embodiment of the present invention; and

FIG. 2 illustrates a diagram of an exemplary three card bottoms up comparing card game, showing an exemplary dealer dealing three dealer cards and three player cards, in accordance with an embodiment of the present invention.

Like reference numerals refer to like parts throughout the various views of the drawings.

### DETAILED DESCRIPTION OF THE INVENTION

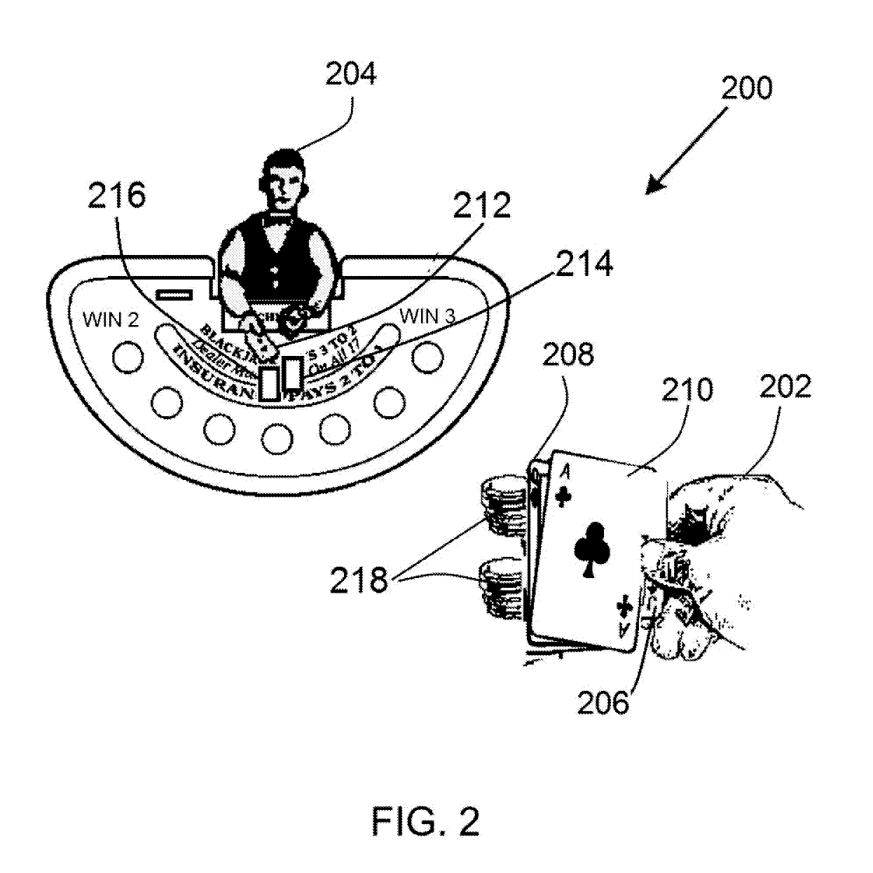

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “first,” “second,” “left,” “rear,” “right,” “front,” “vertical,” “horizontal,” and derivatives thereof shall relate to the invention as oriented in FIG. 2. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

At the outset, it should be clearly understood that like reference numerals are intended to identify the same structural elements, portions, or surfaces consistently throughout the several drawing figures, as may be further described or explained by the entire written specification of which this detailed description is an integral part. The drawings are intended to be read together with the specification and are to be construed as a portion of the entire “written description” of this invention as required by 35 U.S.C. §112.

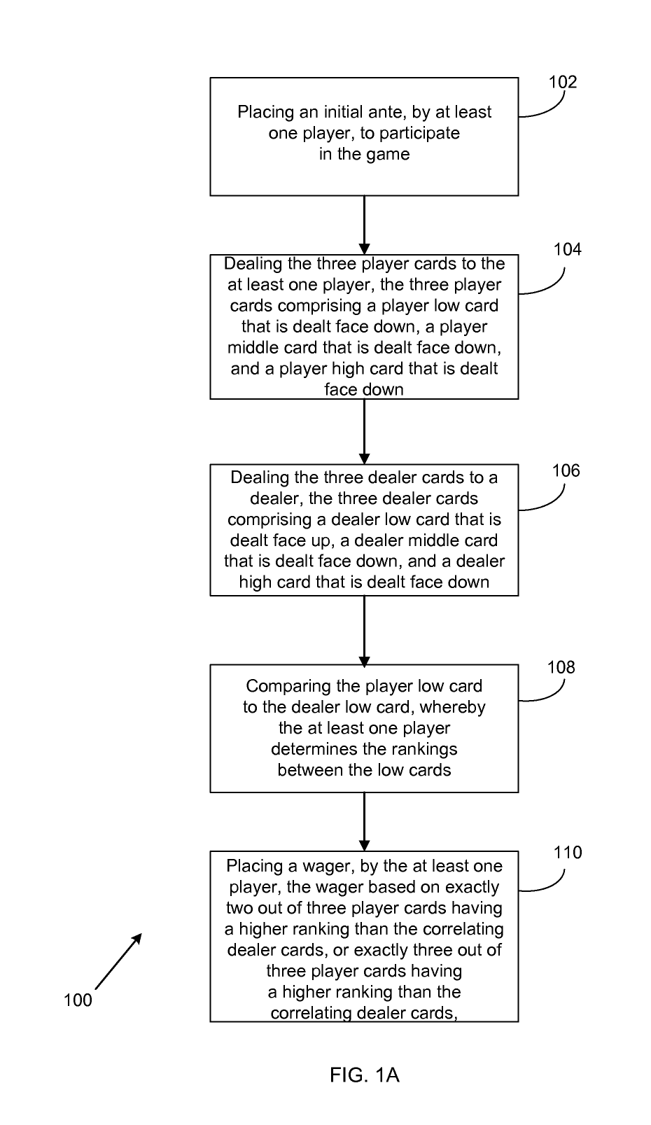

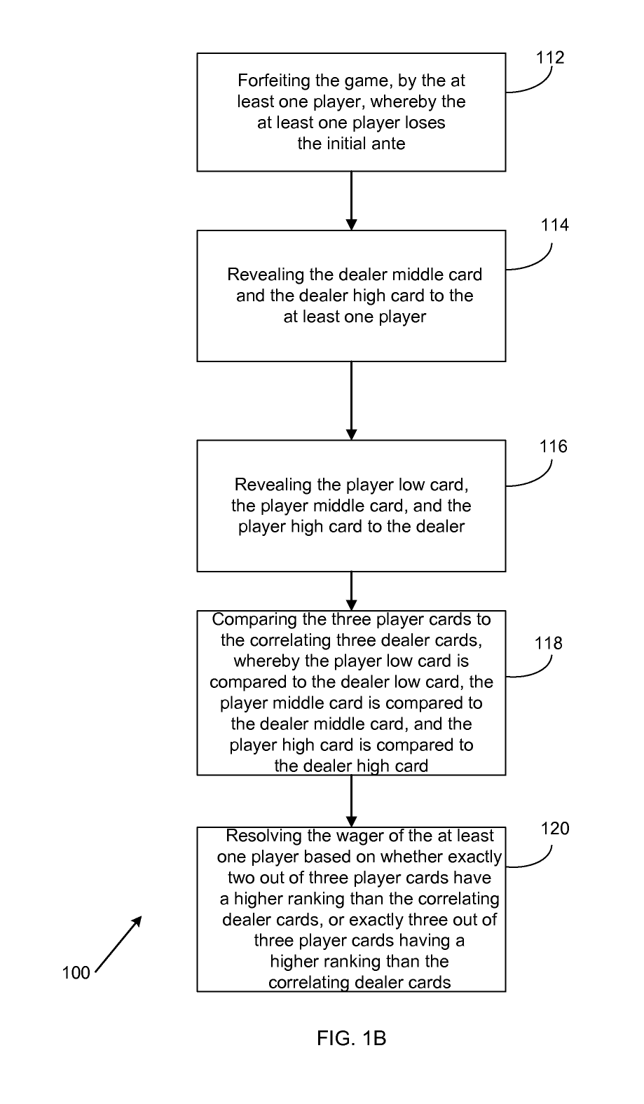

In one embodiment of the present invention presented in FIGS. 1A-2, a method 100 for playing a three card bottoms up comparing card game 200 enables at least one player 202 to wager directly against a dealer 204 by comparing the rankings of three player cards 206, 208, 210 against three correlating dealer cards 212, 214, 216. In one embodiment,

The game 200 commences by dealing three dealer cards 212, 214, 216 to a dealer 204. The three dealer cards 212, 214, 216 include a dealer low card 212 that is visible to the player, and a dealer middle card 214 and a dealer high card 216 that are hidden from view of the player.

The at least one player 202 is then dealt three player cards 206, 208, 210, which are concealed by the respective player 202. The three player cards 206, 208, 210 include a player low card 206, a player middle card 208, and a player high card 210. Since the dealer low card 212 is visible, the player 202 immediately knows the comparing rank of the player low card 206 to the correlating dealer low card 212.

At this point in the game, the player 202 wagers that exactly two out of three player cards 206, 208, 210 have a higher ranking hand than the correlating dealer cards 212, 214, 216. The player 202 may also wager that exactly three out of three player cards 206, 208, 210 have a higher ranking hand than the correlating dealer cards 212, 214, 216. The player 202 may also option to forfeit the game 200, and thereby lose the initial ante. The ranking hand of the cards comprises a ranking number and a ranking suit. For example, an Ace is higher than a Jack. Also, a Spade suit is higher than a Heart suit, a Diamond suit, or a Club suit.

In addition to the wager 218, the player 202 may wager an optional side wager based on the ranking of the player cards 206, 208, 210 and dealer cards 212, 214, 216. The game 200 may be played at a blackjack-type gaming table, or downloadable as a software application. The game 200 also minimizes the detrimental effects of card counting due to the myriad combinations of cards that can be compared and played.

As referenced in the flowchart diagram of FIGS. 1A and 1B, a method 100 for playing a comparing three card bottoms up game 200 utilizes three player cards 206, 208, 210 that are compared against three dealer cards 212, 214, 216 to determine a correlating ranking of each card hand. The method 100 may include an initial Step 102 of placing an initial ante, by at least one player 202, to participate in the game 200. The initial ante may be placed in the form of at least one poker chip, cash, magnetic cards, or monetary unit data input into a processor.

As illustrated in FIG. 2, a Step 104 may further include dealing the three player cards 206, 208, 210 to the at least one player 202, the three player cards 206, 208, 210 comprising a player low card 206 that is dealt face down, a player middle card 208 that is dealt face down, and a player high card 210 that is dealt face down. The player cards 206, 208, 210 are concealed by the player 202, so that the dealer 204 cannot see the face of the player cards 206, 208, 210. However, since the dealer low card 212 is visible, the player 202 immediately knows the comparing rank of the player low card 206 to the correlating dealer low card 212.

Since the dealer 204 generally faces the at least one player 202, the dealer 204 and player 202 place the low, middle, and high cards across directly across from each other by utilizing a right to left—high low ranking for the dealer 204; and a left to right—high low ranking for the player 202. In this manner, the player cards 206, 208, 210 and correlating dealer cards 212, 214, 216 are disposed in a player low card—dealer low card, player middle card—dealer middle card, player high card—dealer high card alignment on the playing table. Thus, the player cards 206, 208, 210 are dealt left to right.

A subsequent Step 106 may include dealing the three dealer cards 212, 214, 216 to a dealer 204, the three dealer cards 212, 214, 216 comprising a dealer low card 212 that is dealt face up, a dealer middle card 214 that is dealt face down, and a dealer high card 216 that is dealt face down, whereby only the dealer low card 212 is visible to the at least one player 202. In one embodiment, the game 200 uses a standard 52-card deck of cards. The cards are shuffled before each deal so that the players can see each other's cards and the dealer 204 does not see the face of the player's cards. However, the players do see the dealer low card 212 at this initial dealing.

After the player 202 places the ante and sits at the table, the three dealer cards 212, 214, 216 are dealt to the dealer 204. The three dealer cards 212, 214, 216 include a dealer low card 212 that is visible to at least one player 202, and a dealer middle card 214 and a dealer high card 216 that are hidden from view of the player 202. The dealer 204 can peek at the dealer cards 212, 214, 216, so as to know which of the cards the dealer low card 212 is, and thereby place the dealer low card 212 face up. However, the player 202 cannot see the dealer middle card 214 or the dealer high card 216. In one possible embodiment, the dealer cards 212, 214, 216 are organized right to left in order from lowest dealer card to highest dealer card.

A Step 108 may include comparing the player low card 206 to the dealer low card 212, whereby the at least one player 202 determines the rankings between the low cards 206, 212. The dealer low card 212 is visible, and the player 202 is aware of all the player cards, so this is generally easy to compare the correlating low cards 206, 212. FIG. 2 shows the player low card 206 as a Jack of Spades, and the dealer low card 212 as a 2 of Clubs. In this instance, the player 202 has a higher ranking lower card.

The method 100 may include a Step 110 of placing a wager 218, by the at least one player 202, the wager 218 based on exactly two out of three player cards 206, 208, 210 having a higher ranking than the correlating dealer cards 212, 214, 216, or exactly three out of three player cards 206, 208, 210 having a higher ranking than the correlating dealer cards 212, 214, 216, whereby the player low card 206 is compared to the dealer low card 212, the player middle card 208 is compared to the dealer middle card 214, and the player high card 210 is compared to the dealer high card 216.

At this point in the game 200, the player 202 wagers that exactly two out of three player cards 206, 208, 210 have a higher ranking hand than the correlating dealer cards 212, 214, 216. The player 202 may also wager that exactly three out of three player cards 206, 208, 210 have a higher ranking hand than the correlating dealer cards 212, 214, 216. The player 202 may also take of the option of forfeiting and losing the initial ante. In one embodiment, the player's wager 218 is equal to, or double the initial ante. In another possible embodiment, the first type of wager is placed on a spot of the card table labeled “Win 2”, while the second type of wager is placed on a “Win 3” spot on the card table.

In an alternative option to wagering, the method 100 may include a Step 112 of forfeiting the game 200, by the at least one player 202, whereby the at least one player 202 loses the initial ante. Though, the player 202 must forfeit prior to seeing the middle and high dealer cards 214, 216. In another alternative to the method 100, the player 202 may place an optional side wager, such as a “3 Card Bonus” and “6-Card Bonus” side wager. For example, if the player cards 206, 208, 210 form a 3-of-a-Kind or a Full Flush, the player 202 may garner additional winnings. The side wager 218 is predetermined and may utilize any side wagering formats known in the art.

A Step 114 comprises revealing the dealer middle card 214 and the dealer high card 216 to the at least one player 202. After the player places the wager 218, the dealer middle card 214 and the dealer high card 216 are made visible to the player 202, so as to commence the comparison between correlating low, middle, and high cards of the player 206, 208, 210 and dealer 212, 214, 216 (player high card-dealer high card; player middle card-dealer middle card; and player low card-dealer low card).

A Step 116 includes revealing the player low card 206, the player middle card 208, and the player high card 210 to the dealer 204. At this stage of the game 200, both sets of cards 206, 208, 210, 212, 214, 216 are visible and the comparison may commence. In one example of Step 116, after all players have folded or made wagers 218, the dealer 204 turns over two face-down cards 214, 216 and arranges them in rank order next to the previously exposed low card 212. The dealer 204 may then go around the card table and, for each player 202 who has not folded, or who has folded but still has an outstanding 3 Card Bonus or 6 Card Bonus wager, the dealer 204 turns over the three player cards 206, 208, 210.

The method 100 may then include a Step 118 of comparing the three player cards 206, 208, 210 to the correlating three dealer cards 212, 214, 216, whereby the player low card 206 is compared to the dealer low card 212, the player middle card 208 is compared to the dealer middle card 214, and the player high card 210 is compared to the dealer high card 216.

In one example of Step 118, if the player 202 has not folded, the dealer 204 orders the player cards 206, 208, 210 in the same way the dealer cards 212, 214, 216 were flipped over for display. The dealer 204 then counts the number of pairwise card comparisons (high-high, middle-middle, and low-low) that the player 202 wins. If the player 202 won 2 out of 3 comparisons and placed the wager 218 on the “Win 2” spot, or if the player 202 won 3 out of 3 comparisons and placed the wager 218 on the “Win 3” spot, the player 202 is paid even money on the initial ante and the wager 218. Otherwise the player 202 loses both wagers 218 and the dealer 204 collects them. If the player 202 made one or both of the wagers 218, the dealer 204 then pays the player 202 out according to the following pay tables by using the three player cards for the 3 Card Bonus bet and combining them with the 3 dealer cards for the 6 Card Bonus bet.

The aforementioned probabilities were analyzed using combinatorial mathematics. The following hand frequencies were calculated:

3 Card Bonus

| | |
|---|---|
| Royal Flush | 4 |
| Straight Flush | 44 |
| Three of a Kind | 52 |
| Straight | 720 |
| Flush | 1096 |
| Pair | 3744 |
| Nothing | 16440 |
| Total | 22100 |

6 Card Bonus

| | |
|---|---|
| 6 Card Royal Flush | 4 |
| 6 Card Str Flush | 32 |
| Royal Flush | 184 |
| Straight Flush | 1624 |
| 4 of a Kind | 14664 |
| Full House | 165984 |
| Flush | 205792 |
| Straight | 361620 |
| 3 of a Kind | 732160 |
| Two Pair | 2532816 |
| Pair of Aces | 751332 |
| One Pair | 8979408 |
| No Pair | 6612900 |
| Total | 20358520 |

Thus, with the given pay tables, the 3 Card Bonus has a House Edge of 7.46% and the 6 Card Bonus has a House Edge of 4.13% of the amount wagered.

Those skilled in the art, in light of the present teachings, will recognize that three player cards 206, 208, 210 and three dealer cards 212, 214, 216 in a 52 card deck create about 1,082,900 possible combinations. For each of these, the possible combinations for the remaining two dealer cards 214, 216 are enumerated and the player and dealer high, middle, and low cards 206, 208, 210, 212, 214, 216 were compared. If either the player 202 wins 2 of 3, or the player wins 3 of 3 wagering scenario occurred for more than one third of the combinations of the two remaining dealer cards, the player 202 was assumed to bet on the more common of those two cases. Otherwise, the player 202 was assumed to fold, because those skilled in the art recognize that winning a 3-unit wager less than ⅓ of the time is worse than losing 1 unit for certain.

Thus, the game 200 is configured, such that the optimal strategy for the player 202 involves folding 42.34%-42.53% of the time, betting on “Win 2” 26.36-26.53% of the time, and betting on “Win 3” 31.13%-31.30% of the time. Though, the probabilities are not exact because in some cases two possible strategic choices have equal average winnings. The average House Edge when the player 202 plays optimally is 7.69% of an Ante bet, the average amount wagered is 2.15 Ante units, and the House Edge averages 3.58% of the total amount wagered.

The method 100 also provides interesting analysis related to card counting possibilities by the player 202. The analysis assumes that the player 202 has seen other cards than the player's own player card 206, 208, 210 and the dealer's visible low card 212 (but not the dealer's two face-down cards 214, 216). This is relevant in the situation where multiple player 202s show each other their player cards or their cards are dealt face up.

For example, when the player 202 was assumed to have seen 13 additional cards, the House Edge drops from 7.69% of the Ante to 6.37% of the Ante (3.58% of the total wagered to 2.97% of the total wagered). When the player 202 was assumed to have seen 26 additional cards, the House Edge drops from 7.69% of the Ante to 3.48% of the Ante (3.58% of the total wagered to 1.63% of the total wagered). Thus, conclusively, if the players 202 are not required to keep their cards face down, the game 200 still favors the House, and “Card Counting” cannot gain a player advantage.

A final Step 120 includes resolving the wager 218 of the at least one player 202 based on whether exactly two out of three player cards 206, 208, 210 have a higher ranking than the correlating dealer cards 212, 214, 216, or exactly three out of three player cards 206, 208, 210 having a higher ranking than the correlating dealer cards 212, 214, 216, whereby the player low card 206 is compared to the dealer low card 212, the player middle card 208 is compared to the dealer middle card 214, and the player high card 210 is compared to the dealer high card 216. The player 202 wins the wager 218 and ante if the player low card 206 ranks higher than the dealer low card 212, and/or the player middle card 208 ranks higher than the dealer middle card 214, and/or the player high card 210 ranks higher than the dealer high card 216.

The higher ranking hand comprises a higher ranking number and a higher ranking suit. By including a suit ranking, a push is avoided. The rankings of the suit may include a Spade suit being the highest ranking, a Heart suit being the next highest ranking, a Diamond suit being the next highest ranking, and a Club suit being the lowest ranking suit. Thus in this ranking configuration, the lowest card is the 2 of Clubs and the highest card is the Ace of Spades. Though in some alternative embodiments, the rankings of the suits may follow any order and be predetermined before commencing the game 200.

For example, without limitation, a 7 of Spades player low card ranks higher than a 2 of Spades dealer low card. A 9 of Hearts player middle card ranks lower than a Queen of Hearts dealer middle card. An Ace of Hearts player high card ranks higher than an Ace of Spades dealer high card. In this example, the player 202 would beat the dealer 204 if the player 202 had wagered that exactly two out of three player cards have a higher ranking hand than the correlating dealer cards. However, the player 202 would have lost to the dealer 204 if the player 202 had wagered that exactly three out of three player cards have a higher ranking hand than the correlating dealer cards.

Those skilled in the art will recognize that comparing games often use a standard technique of ranking the value of hands. The ranking of hands is based on rarity, and is as follows (from most valuable to least valuable):

Straight Flush: five cards of the same suit, in order (Q-J-10-9-8 of spades)

Four of a Kind: four cards of the same value, and one extra card (J-J-J-J-7)

Full House: three cards of one value, plus two of another (A-A-A-3-3)

Flush: five cards of the same suit (A-J-9-7-2 of clubs)

Straight: five cards in sequence, Aces may be low or high (9-8-7-6-5)

Three of a Kind: three cards of the same value, and two extra (5-5-5-K-Q)

Two Pair: two cards of one value plus two cards of another (10-10-6-6-Q)

One Pair: two cards of one value, and three extra (A-A-9-5-2)

It is also significant to note that hands higher in the list are more rare (the odds of attaining them are higher), and therefore more valuable and beat hands lower on the list. If more than one player 202 has the same type of hand (e.g. three of a kind), higher cards beat lower cards (Aces are the highest, then Kings, Queens, Jacks, 10s, and so on). So, three Queens beats three Jacks.

As discussed above, the player 202 may place a side wager in addition to the standard wager 218. In one embodiment, a 3 Card Bonus side wager wins for the player 202 if the following hands are achieved in the player cards 206, 208, 210:

| | |
|---|---|
| Royal Flush (suited AKQ) | 100 to 1 |
| Straight Flush | 50 to 1 |
| Three of a Kind | 30 to 1 |
| Straight | 5 to 1 |
| Flush | 3 to 1 |
| Pair | 1 to 1 |
| No pair | Loss |

Similarly, a 6 Card Bonus side wager wins for the player 202 if the following hands are achieved in the player cards 206, 208, 210:

| | |
|---|---|
| 6 Card Royal Flush | 10,000 to 1 |
| 6 Card Straight Flush | 5,000 to 1 |
| 5 Card Royal Flush | 1,000 to 1 |
| 5 Card Straight Flush | 250 to 1 |
| Four of a Kind | 50 to 1 |
| Full House | 15 to 1 |
| Flush | 10 to 1 |
| Straight | 5 to 1 |
| Three of a Kind | 3 to 1 |
| Two Pair | 2 to 1 |
| One pair or worse | Loss |

In another alternative embodiment, the method 100 is played through a downloadable software application. The method 100 may be stored on a remote server and accessed through the Internet. In another embodiment, the comparing three card bottoms up card game 200 is played on a video game console, a smartphone, and a gaming computer. In yet another embodiment, multiple players in different regions may interactively play against each other and a virtual dealer, such as a chatbot.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What I claim is:

1. A method for playing a three card bottoms up comparing card game, the method comprising:
placing an initial ante, by at least one player, to participate in the game;
dealing the three player cards to the at least one player, the three player cards comprising a player low card that is dealt face down, a player middle card that is dealt face down, and a player high card that is dealt face down;
dealing the three dealer cards to a dealer, the three dealer cards comprising a dealer low card that is dealt face up, a dealer middle card that is dealt face down, and a dealer high card that is dealt face down, whereby only the dealer low card is visible to the at least one player;
comparing the player low card to the dealer low card, whereby the at least one player determines the rankings between the low cards;
placing a wager, by the at least one player, the wager based on exactly two out of three player cards having a higher ranking than the correlating dealer cards, or exactly three out of three player cards having a higher ranking than the correlating dealer cards, whereby the player low card is compared to the dealer low card, the player middle card is compared to the dealer middle card, and the player high card is compared to the dealer high card;
forfeiting the game, by the at least one player, whereby the at least one player loses the initial ante;
revealing the dealer middle card and the dealer high card to the at least one player;
revealing the player low card, the player middle card, and the player high card to the dealer;
comparing the three player cards to the correlating three dealer cards, whereby the player low card is compared to the dealer low card, the player middle card is compared to the dealer middle card, and the player high card is compared to the dealer high card; and
resolving the wager of the at least one player based on whether exactly two out of three player cards have a higher ranking than the correlating dealer cards, or exactly three out of three player cards having a higher ranking than the correlating dealer cards, whereby the player low card is compared to the dealer low card, the player middle card is compared to the dealer middle card, and the player high card is compared to the dealer high card.

2. The method of claim 1, wherein the game is a comparing card game.

3. The method of claim 1, wherein the method is played with a base deck of 52 playing cards, each card having a unique combination of a value selected from a group of thirteen values and a suit selected from a group of four suits.

4. The method of claim 1, wherein the wagering amount and the initial ante include at least one poker chip.

5. The method of claim 1, wherein the ranking comprises a Spade suit being the highest ranking suit, a Heart suit being the next highest ranking suit, a Diamond suit being the next highest ranking suit, and a Club suit being the lowest ranking suit.

6. The method of claim 1, wherein the wager of the at least one player based on whether exactly two out of three player cards have a higher ranking than the correlating dealer cards is placed on a spot labeled Win 2.

7. The method of claim 1, wherein the wager of the at least one player based on whether exactly three out of three player cards have a higher ranking than the correlating dealer cards is placed on a spot labeled Win 3.

8. The method of claim 1, further including a step of placing a first optional side wager based on the ranking of the three player cards.

9. The method of claim 1, further including a step of placing a second optional side wager based on the best five-card hand drawn from the six cards dealt to the at least one player and the dealer.

10. The method of claim 1, wherein the method is played on a casino table game.

11. The method of claim 1, wherein the method is played through a downloadable software application.

12. A non-transitory program storage device readable by a machine tangibly embodying a program of instructions executable by the machine to perform a method for playing a three card bottoms up comparing card game, the method comprising:
computer code for placing an initial ante, by at least one player, to participate in the game;
computer code for dealing the three player cards to the at least one player, the three player cards comprising a player low card that is dealt face down, a player middle card that is dealt face down, and a player high card that is dealt face down;
computer code for dealing the three dealer cards to a dealer, the three dealer cards comprising a dealer low card that is dealt face up, a dealer middle card that is dealt face down, and a dealer high card that is dealt face down, whereby only the dealer low card is visible to the at least one player;
computer code for comparing the player low card to the dealer low card, whereby the at least one player determines the rankings between the low cards;
computer code for placing a wager, by the at least one player, the wager based on exactly two out of three player cards having a higher ranking than the correlating dealer cards, or exactly three out of three player cards having a higher ranking than the correlating dealer cards, whereby the player low card is compared to the dealer low card, the player middle card is compared to the dealer middle card, and the player high card is compared to the dealer high card;
computer code for forfeiting the game, by the at least one player, whereby the at least one player loses the initial ante;
computer code for revealing the dealer middle card and the dealer high card to the at least one player;
computer code for revealing the player low card, the player middle card, and the player high card to the dealer;
computer code for comparing the three player cards to the correlating three dealer cards, whereby the player low card is compared to the dealer low card, the player middle card is compared to the dealer middle card, and the player high card is compared to the dealer high card; and
computer code for resolving the wager of the at least one player based on whether exactly two out of three player cards have a higher ranking than the correlating dealer cards, or exactly three out of three player cards having a higher ranking than the correlating dealer cards, whereby the player low card is compared to the dealer low card, the player middle card is compared to the dealer middle card, and the player high card is compared to the dealer high card.

13. The method of claim 12, wherein the method is played through a downloadable software application.

14. A method for playing a three card bottoms up comparing card game, the method comprising:
placing an initial ante, by at least one player, to participate in the game;
dealing the three player cards to the at least one player, the three player cards comprising a player low card that is dealt face down, a player middle card that is dealt face down, and a player high card that is dealt face down;
dealing the three dealer cards to a dealer, the three dealer cards comprising a dealer low card that is dealt face up, a dealer middle card that is dealt face down, and a dealer high card that is dealt face down, whereby only the dealer low card is visible to the at least one player;
comparing the player low card to the dealer low card, whereby the at least one player determines the rankings between the low cards;
placing a wager, by the at least one player, the wager based on exactly two out of three player cards having a higher ranking than the correlating dealer cards, or exactly three out of three player cards having a higher ranking than the correlating dealer cards, whereby the player low card is compared to the dealer low card, the player middle card is compared to the dealer middle card, and the player high card is compared to the dealer high card;
placing a first optional side wager based on the ranking of the three player cards;
placing a second optional side wager based on the best 5-card hand drawn from the 6 cards dealt to the at least one player and the dealer;
forfeiting the game, by the at least one player, whereby the at least one player loses the initial ante;
revealing the dealer middle card and the dealer high card to the at least one player;
revealing the player low card, the player middle card, and the player high card to the dealer;
comparing the three player cards to the correlating three dealer cards, whereby the player low card is compared to the dealer low card, the player middle card is compared to the dealer middle card, and the player high card is compared to the dealer high card; and
resolving the wager of the at least one player based on whether exactly two out of three player cards have a higher ranking than the correlating dealer cards, or exactly three out of three player cards having a higher ranking than the correlating dealer cards, whereby the player low card is compared to the dealer low card, the player middle card is compared to the dealer middle card, and the player high card is compared to the dealer high card.

15. The method of claim 14, wherein the game is a comparing card game.

16. The method of claim 14, wherein the method is played with a base deck of 52 playing cards, each card having a unique combination of a value selected from a group of thirteen values and a suit selected from a group of four suits.

17. The method of claim 14, wherein the wagering amount and the initial ante include at least one poker chip.

18. The method of claim 14, wherein the ranking comprises a Spade suit being the highest ranking suit, a Heart suit being the next highest ranking suit, a Diamond suit being the next highest ranking suit, and a Club suit being the lowest ranking suit.

19. The method of claim 14, wherein the method is played on a casino table game.

20. The method of claim 14, wherein the method is played through a downloadable software application.
